(19) United States
(12) Patent Application Publication
(10) Pub. No.: US 2022/0322057 A1
(43) Pub. Date: Oct. 6, 2022

(54) WIRELESS COMMUNICATION APPARATUS AND VEHICLE

(71) Applicants: TOYOTA JIDOSHA KABUSHIKI KAISHA, Toyota-shi (JP); DENSO TEN Limited, Kobe (JP)

(72) Inventors: Takuma SAWAYA, Nagoya-shi (JP); Hironobu YAMAMOTO, Toyota-shi (JP); Noriaki ITO, Toyota-shi (JP); Hiroki KAWASAKI, Toyota-shi (JP); Hiroto NAKAGAWA, Nagoya-shi (JP); Satoru IKEDA, Kobe (JP)

(73) Assignees: TOYOTA JIDOSHA KABUSHIKI KAISHA, Toyota-shi (JP); DENSO TEN Limited, Kobe (JP)

(21) Appl. No.: 17/706,966

(22) Filed: Mar. 29, 2022

(30) Foreign Application Priority Data
Mar. 31, 2021 (JP) 2021-061934

(51) Int. Cl. H04W 4/40; H04M 1/02

(52) U.S. Cl. CPC H04W 4/40; H04M 1/026

(57) ABSTRACT

The present disclosure in its one aspect provides a wireless communication apparatus comprising a communication module configured to perform wireless communication with an external network of a vehicle; and a first antenna connected to the communication module, wherein the wireless communication apparatus is mounted at a position close to a roof panel of the vehicle.

### CROSS REFERENCE TO THE RELATED APPLICATION

This application claims the benefit of Japanese Patent Application No. 2021-061934, filed on Mar. 31, 2021, which is hereby incorporated by reference herein in its entirety.

### BACKGROUND

### Technical Field

The present disclosure relates to a wireless communication technology.

### Description of the Related Art

A system in which a computer mounted in a vehicle performs wireless communication is widely used.

In relation to this, Japanese Patent Laid-Open No. 2011-130115 discloses a technology related to an arrangement position of a communication antenna that is mounted in the vehicle, for example.

### SUMMARY

The present disclosure is aimed at improving wireless signal transmission efficiency.

The present disclosure in its one aspect provides a wireless communication apparatus comprising: a communication module configured to perform wireless communication with an external network of a vehicle; and a first antenna connected to the communication module, wherein the wireless communication apparatus is mounted at a position close to a roof panel of the vehicle.

The present disclosure in its another aspect provides a vehicle comprising a wireless communication apparatus that is mounted at a position close to a roof panel, the wireless communication apparatus including a communication module configured to perform wireless communication with an external network of the vehicle, and a first antenna connected to the communication module.

According to the present disclosure, wireless signal transmission efficiency can be improved.

### BRIEF DESCRIPTION OF THE DRAWINGS

FIG. 1 is a schematic diagram illustrating an example configuration of a vehicle system according to an embodiment;

FIG. 2 is a schematic diagram illustrating an example configuration of a DCM and vehicle components;

FIG. 3 is a block diagram schematically illustrating an example functional configuration of the DCM;

FIG. 4 is a hardware external view of the DCM;

FIG. 5 is a view for describing an arrangement position of the DCM according to a first embodiment;

FIG. 6 is a cross-sectional view for describing the arrangement position of the DCM;

FIG. 7 is a perspective view illustrating a structure of a roof of a vehicle; and

FIG. 8 is a view for describing an arrangement position of the DCM according to a second embodiment.

### DESCRIPTION OF THE EMBODIMENTS

A growing number of vehicles include a communication terminal mounted therein. Furthermore, these days, vehicle functions are being improved, thereby resulting in an increase in the amount of communication data, and there is a demand to maximize communication efficiency.

A wireless communication apparatus according to an embodiment of the present disclosure includes a communication module configured to perform wireless communication with an external network of a vehicle, and a first antenna connected to the communication module, where the wireless communication apparatus is mounted at a position close to a roof panel of the vehicle.

The wireless communication apparatus performs input/output of wireless signals via the antenna. The antenna is disposed at a position where outside of the vehicle can be seen (such as near a windshield). Particularly, with a wireless communication apparatus that uses radio waves in a high frequency band having high rectilinearity, the antenna is often disposed at an upper part of the vehicle (such as near the roof) to secure the above ground level.

However, a main body of the apparatus where the communication module is housed is usually disposed in an engine compartment or an instrument panel, and thus, in the case where the antenna is disposed at an upper part of the vehicle, the main body of the apparatus and the antenna have to be connected by a coaxial cable. This may result in problems such as an increase in cost or a reduction in gain.

In view of such a situation, the communication module and the antenna of the wireless communication apparatus according to the present disclosure are both disposed near the roof panel of the vehicle. This allows the above ground level of the antenna to be secured, and a distance between the antenna and the communication module to be minimized.

Note that the network outside the vehicle includes a network (such as a V2X network) with a direct connection, such as inter-vehicle communication or road-to-vehicle communication.

Furthermore, the wireless communication apparatus may be mounted between the roof panel and a roof lining of the vehicle.

The roof panel is a member forming the roof of the vehicle. A material and the like of the roof panel are not limited as long as the roof panel forms the roof of the vehicle. For example, a steel plate, a resin panel or the like may be used.

The roof lining is an interior material disposed at a roof portion of the vehicle.

Furthermore, the communication module may perform the wireless communication by V2X communication.

The wireless communication apparatus according to the present disclosure may be suitably applied to an apparatus that performs V2X communication that uses radio waves in a high frequency band.

Furthermore, the wireless communication apparatus may further include a port to which a second antenna is connected, the second antenna being an external antenna for the V2X communication.

Furthermore, the second antenna may be disposed at an upper part of a windshield of the vehicle.

With a V2X communication apparatus that uses radio waves in a high frequency band, an external antenna is sometimes connected to maintain directivity. Particularly, by installing an external antenna at an upper part of the windshield, a directivity axis can be made to face a travel direction of the vehicle, and safety of traveling can be improved.

The wireless communication apparatus according to the present disclosure is disposed near the roof panel, and a distance to such an external antenna can be made as short as possible. That is, a loss of wireless signal due to presence of a cable can be minimized.

Furthermore, the wireless communication apparatus may relay communication that is performed by an electronic control module that provides a vehicle function that uses the V2X communication.

The wireless communication apparatus may be an apparatus that mediates communication that is performed by an electronic control module (such as an autonomous driving ECU) that uses a vehicle-to-everything (V2X) function.

Furthermore, the communication module may further perform wireless communication with the external network of the vehicle by cellular communication.

In this manner, the communication module may perform communication by other than a direct connection method.

Furthermore, the wireless communication apparatus may implement a function of transmitting position information of the wireless communication apparatus.

As such a service, there may be cited an emergency report service, a security monitoring service or the like, for example. The wireless communication apparatus is an apparatus that mediates communication inside the vehicle, but by enabling such an important service to be independently performed, availability of the service can be ensured.

Furthermore, the wireless communication apparatus may further include a third antenna configured to receive a signal transmitted from a positioning satellite. The third antenna may be disposed near the first antenna.

In the following, specific embodiments of the present disclosure will be described with reference to the drawings. A hardware configuration, a module configuration, a functional configuration and the like described in each embodiment are not intended to limit the technical scope of the disclosure thereto unless stated otherwise.

### First Embodiment

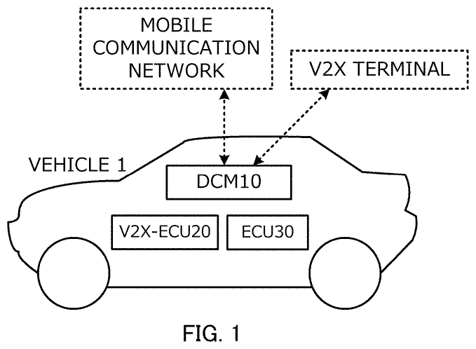

An outline of a vehicle system according to a first embodiment will be given with reference to FIG. 1. The vehicle system according to the present embodiment includes a vehicle 1.

The vehicle 1 is a connected car having a function of communicating with an external apparatus. The vehicle 1 includes a data communication module (DCM) 10, a V2X-ECU 20, and a plurality of ECUs 30.

The external apparatus is an apparatus outside the vehicle 1. For example, the external apparatus may be a server apparatus connected to the Internet, or a vehicle-mounted terminal (mounted in another vehicle), a roadside apparatus or the like capable of directly communicating with the DCM 10 and existing near the vehicle 1.

The V2X-ECU 20 is an electronic control unit, among a plurality of electronic control units of the vehicle 1, that provides a vehicle function that uses V2X communication. As such a function, an autonomous driving function, an information providing function based on inter-vehicle (road-to-vehicle) communication or the like may be cited, for example.

The ECU 30 is an electronic control unit, among the plurality of electronic control units of the vehicle 1, that uses communication other than V2X communication.

The DCM 10 is an apparatus that performs wireless communication with another apparatus (or an external network) via a network. The DCM 10 functions as a gateway for connecting a component (hereinafter “vehicle component”) of the vehicle 1 to an external network of the vehicle or to an external apparatus.

The DCM 10 is capable of providing two types of communication.

First communication is communication to a mobile communication network. The mobile communication network is connected to a wide area network such as the Internet, and a vehicle component can thus communicate with a freely selected external apparatus. The first communication is performed using cellular communication.

Second communication is communication to another vehicle located near the vehicle 1 or a communication apparatus (hereinafter “V2X terminal”) mounted in a roadside apparatus. The second communication is also referred to as V2X communication. The second communication is performed using radio waves such as centimeter waves or millimeter waves.

The amount of communication data to be handled by the DCM that is mounted in the vehicle is expected to increase in the future as vehicle functions improve. Accordingly, there is a demand to improve communication efficiency of the DCM.

Accordingly, with the DCM 10 according to the present embodiment, the antenna and the communication module are both installed near the roof of the vehicle, at a position not affected by a body. A line of sight between communication apparatuses can thus be secured, and also, a cable for connecting the antenna and the communication module can be made as short as possible. A specific arrangement method will be described later.

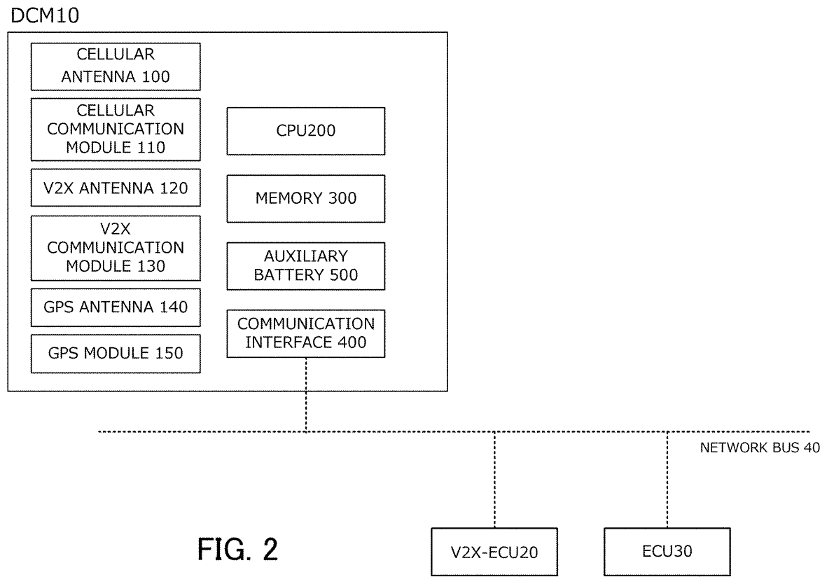

FIG. 2 is a diagram for describing components of the DCM 10 according to the present embodiment. The DCM 10 according to the present embodiment includes a cellular antenna 100, a cellular communication module 110, a V2X antenna 120, a V2X communication module 130, a GPS antenna 140, a GPS module 150, a CPU 200, a memory 300, a communication interface 400, and an auxiliary battery 500.

The cellular antenna 100 is an antenna element to which wireless signals are input/output. In the present embodiment, the cellular antenna 100 is compatible with cellular communication (for example, mobile communication such as 3G, LTE or 5G). The cellular antenna 100 may include a plurality of physical antennas. For example, in the case of using mobile communication at high frequency, a plurality of antennas may be disposed in a distributed manner to stabilize communication.

The cellular communication module 110 is a communication module for performing mobile communication.

The V2X antenna 120 is an antenna element to which wireless signals used for V2X communication are input/output. In the present embodiment, the V2X antenna 120 is compatible with V2X communication that uses dedicated short range communications (DSRC) or the like. The V2X antenna 120 may include a plurality of physical antennas. For example, a plurality of antennas facing different directions may be used as the V2X antenna 120.

The V2X communication module 130 is a communication module for performing V2X communication.

The GPS antenna 140 is an antenna that receives positioning signals transmitted from a positioning satellite (also referred to as “GNSS”).

The GPS module 150 is a module that calculates position information based on signals received by the GPS antenna 140.

The CPU 200 is an arithmetic unit that implements various functions of the DCM 10 by executing predetermined programs.

The memory 300 is a memory device that includes a main memory and an auxiliary memory. The auxiliary memory stores an operating system (OS), various programs, various tables and the like, and functions matching predetermined objects as described later can be implemented by loading the programs stored in the auxiliary memory into the main memory and by executing the same.

The CPU 200 implements a function of mediating communication that is performed between an external apparatus and a component (a vehicle component) of the vehicle 1. The vehicle component is the V2X-ECU 20 or the ECU 30, for example. The external apparatus may be a server apparatus that provides information to the ECU 30, or a V2X terminal that provides traffic information to the V2X-ECU 20, for example.

In the case where a certain vehicle component needs to perform communication with an external apparatus, for example, the CPU 200 implements a function of relaying data transmitted from the vehicle component to the external apparatus (or an external network). Furthermore, the CPU 200 implements a function of receiving data transmitted from an external apparatus (or an external network) and of transferring the data to an appropriate vehicle component.

The CPU 200 may further implement a function unique to the own apparatus. For example, the CPU 200 is capable of implementing a monitoring function of a security system or a call function, and of making a security report, an emergency report or the like based on a trigger occurring inside the vehicle.

The communication interface 400 is an interface unit for connecting the DCM 10 to an in-vehicle network. In the present embodiment, a plurality of vehicle components including the electronic control units (the V2X-ECU 20, the ECUs 30) are interconnected by a network bus 40. For example, a controller area network (CAN) may be cited as an example of a standard for the in-vehicle network. In the case where the in-vehicle network uses a plurality of standards, the communication interface 400 may include a plurality of interface devices according to the standards of communication destinations. For example, Ethernet (registered trademark) or the like may be cited as an example of a communication standard other than CAN.

The auxiliary battery 500 is a battery that supplies backup power to the DCM 10. The DCM 10 operates on power supplied from the vehicle 1, but supply of power may sometimes be cut off due to a traffic accident or an illicit act, for example. The auxiliary battery 500 supplies power to the DCM 10 in such a case. The DCM 10 can thus continue to operate even in times of emergency. The auxiliary battery 500 may be charged when power is being supplied from the vehicle 1.

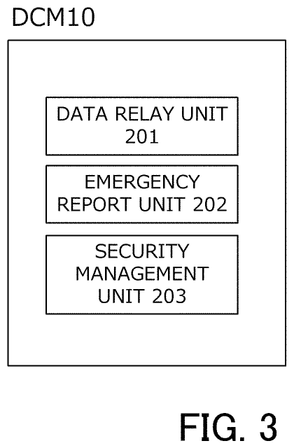

Next, functions to be implemented by the CPU 200 will be described. FIG. 3 is a diagram for describing functional modules of the DCM 10. The functional modules illustrated may be implemented by the CPU 200 executing programs stored in storage unit such as a ROM.

A data relay unit 201 relays data that is transmitted/received between vehicle components, and for example, performs a process of receiving a message that is transmitted by a first apparatus connected to the in-vehicle network and of transferring the message, as necessary, to a second apparatus connected to the in-vehicle network. The first and second apparatuses may be the V2X-ECU 20, the ECU 30, or other vehicle components.

Furthermore, in the case where a message destined for an external apparatus is received from a vehicle component, the data relay unit 201 relays the message to an external network. Furthermore, the data relay unit 201 receives data transmitted from an external network, and transfers the data to an appropriate vehicle component.

In the case where an abnormal situation occurs in the vehicle 1, an emergency report is made by an emergency report unit 202 to an operator outside the vehicle. Occurrence of a traffic accident or a vehicle breakdown may be cited as examples of the abnormal situation. For example, in the case where a predetermined trigger is issued, such as when a call button provided in the vehicle is pressed or an air bag is inflated, the emergency report unit 202 starts connection to the operator, and enables communication between an occupant of the vehicle and the operator. At the time of reporting emergency, the emergency report unit 202 may transmit position information of the vehicle to the operator. In this case, the emergency report unit 202 may acquire the position information from the GPS module 150.

A security management unit 203 performs a security monitoring process. For example, the security management unit 203 detects that the vehicle is unlocked without a regular procedure, based on data received from the ECU 30 managing an electronic lock of the vehicle, and transmits a security report to a predetermined apparatus. The security report may include the position information of the vehicle. In this case, the security management unit 203 may acquire the position information from the GPS module 150. In the case of determining occurrence of a problem in relation to security of the own vehicle, the security management unit 203 may acquire the position information, and periodically transmit the acquired position information to an external apparatus specified in advance.

The V2X-ECU 20 is an electronic control unit that provides a V2X function. For example, as the V2X function, a function of preventing collision of vehicles and the like by exchanging data with other vehicles by inter-vehicle communication, a function of acquiring data about traffic lights and the like by road-to-vehicle communication, and the like may be cited. The V2X function may be provided as a part of an autonomous driving function. In this case, the V2X-ECU 20 may be an ECU that provides the autonomous driving function (ADAS function), for example.

The V2X-ECU 20 implements a function of generating a specified message and of periodically transmitting the same by broadcast to outside the vehicle, a function of acquiring a message transmitted from another V2X terminal and of controlling traveling of the own vehicle based on the message, and the like.

The ECU 30 is an electronic control unit that controls a component of the vehicle 1. The present example illustrates one ECU 30, but a plurality of ECUs 30 may be included in the vehicle 1. The plurality of ECUs 30 control components of different systems, such as an engine system, an electrical system and a powertrain system, for example. The ECU 30 has a function of generating a specified message, and of periodically transmitting and receiving messages via the in-vehicle network. Furthermore, the ECU 30 may provide a remote service (such as a remote air-conditioning service) or the like by communicating with an external apparatus via the DCM 10.

Like the DCM 10, the V2X-ECU 20 and the ECU 30 may each be a computer including processors such as a CPU and a GPU, main memories such as a RAM and a ROM, and auxiliary memories such as an EPROM, a disk drive and a removable medium.

The network bus 40 is a communication bus included in the in-vehicle network. In the present example, one bus is illustrated as an example, but the vehicle 1 may include two or more communication buses. A plurality of communication buses may be interconnected by the DCM 10 or a gateway coordinating the plurality of communication buses.

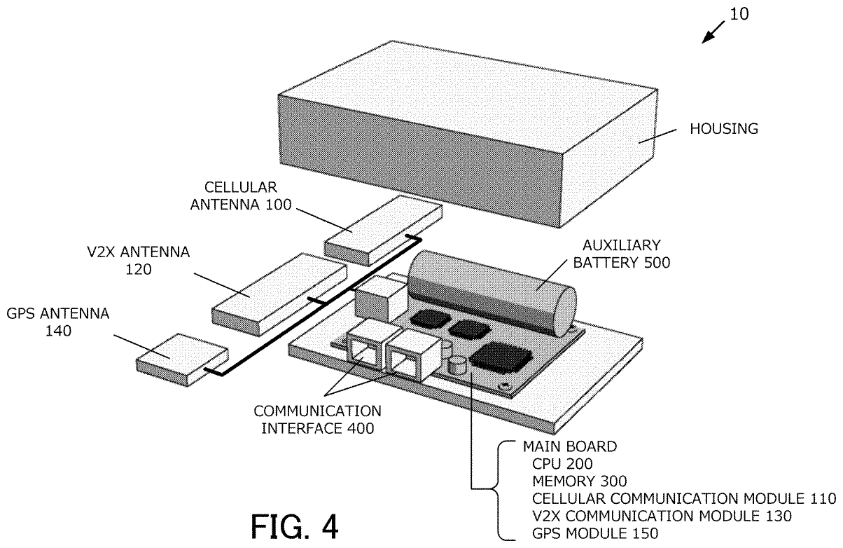

FIG. 4 is a diagram illustrating an appearance of hardware of the DCM 10.

The hardware of the DCM 10 includes a main board, the cellular antenna 100, the V2X antenna 120, the GPS antenna 140, and the auxiliary battery 500.

The main board is a board where the CPU 200, the memory 300, the cellular communication module 110, the V2X communication module 130, the GPS module 150, and the communication interface 400 are mounted. Moreover, the main board is connected, via external ports, to the cellular antenna 100, the V2X antenna 120, and the GPS antenna 140.

The main board, the cellular antenna 100, the V2X antenna 120, and the GPS antenna 140 form the wireless communication apparatus according to the present disclosure.

In the present example, the communication interface 400 includes a plurality of connectors. One of the plurality of connectors corresponds to an in-vehicle network bus such as CAN or Ethernet. Furthermore, another connector may be a connector for extension. As such a connector, a port for connecting an external antenna to the DCM 10, an USB port for connecting an external appliance (such as a terminal for maintenance) to the DCM 10, and the like may be cited as examples.

The hardware illustrated in the drawing is disposed near the roof panel of the vehicle 1.

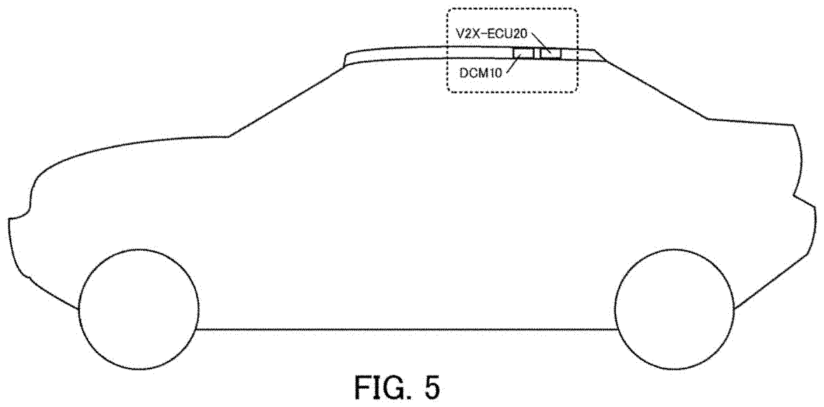

FIG. 5 is a diagram for describing a position where the hardware illustrated in FIG. 4 is disposed. As illustrated in the drawing, the DCM 10 and the V2X-ECU 20 are disposed between the roof panel and the roof lining of the vehicle.

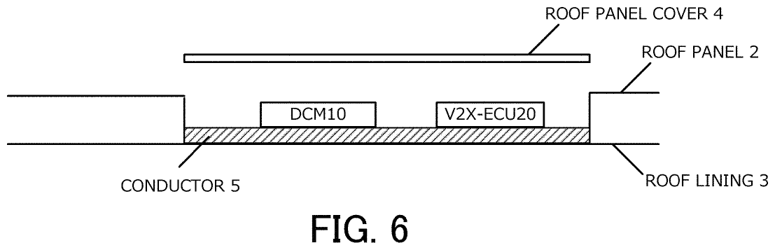

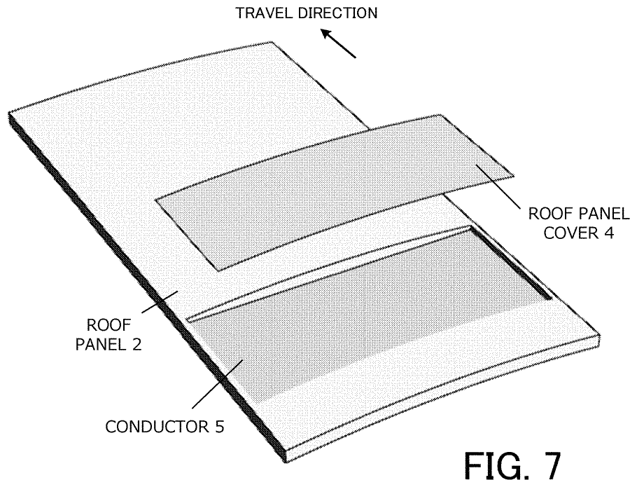

The arrangement position of the apparatus will be described in greater detail. FIG. 6 is a cross-sectional view illustrating a dotted part in FIG. 5 in an enlarged manner. Furthermore, FIG. 7 is a bird's-eye view around the roof of the vehicle 1.

A reference sign 2 is the roof panel, a reference sign 3 is the roof lining (an interior member), a reference sign 4 is a roof panel cover made of resin, and a reference sign 5 is a conductor.

The roof panel 2 and the roof panel cover 4 correspond to “roof panel” according to the present disclosure.

With the vehicle 1 according to the present embodiment, a cutout is provided in the roof panel 2, and the DCM 10 and the V2X-ECU 20 are housed in a space between the roof panel 2 and the roof lining 3. The conductor 5 that is grounded is desirably disposed at a bottom of the space. Noise immunity in communication can thus be improved. However, the conductor 5 is not essential. The cutout is covered by the roof panel cover 4 made of resin.

According to the configuration illustrated, the above ground level of the V2X antenna can be secured, and a line of sight to other V2X terminals can be secured. Furthermore, a distance between the V2X antenna and the V2X communication module can be reduced as much as possible, and a signal loss can be reduced. The same can be said for the cellular antenna and the cellular communication module.

With a conventional DCM, the main board and the antenna are connected by a coaxial cable. For example, the housing where the V2X antenna is housed is disposed near the roof panel, and the cable has to be routed to a DCM main body (a housing where the main board is housed).

Conventionally, the main body of the DCM is disposed at a position where other ECUs 30 are stored, such as at the back of a glove compartment, under a seat, inside a center console, or in an engine compartment, for example. According to such a configuration, a signal loss is caused due to presence of the cable, and an amplifier has to be additionally provided to compensate for such a loss, for example.

By contrast, with the DCM 10 according to the present embodiment, a distance between the antenna and the main board can be minimized. That is, wireless signal transmission efficiency can be increased. Accordingly, a coaxial cable and an amplifier for compensating for transmission loss become unnecessary, and a manufacturing cost of the appliance can be reduced.

### Second Embodiment

The DCM 10 according to the first embodiment performs V2X communication using one V2X antenna 120. However, because V2X communication uses radio waves in a high frequency band having high rectilinearity, it is desirable to dispose the V2X antenna at a plurality of different positions to eliminate blind spots. A second embodiment is an embodiment in which an external antenna is added to use a plurality of V2X antennas.

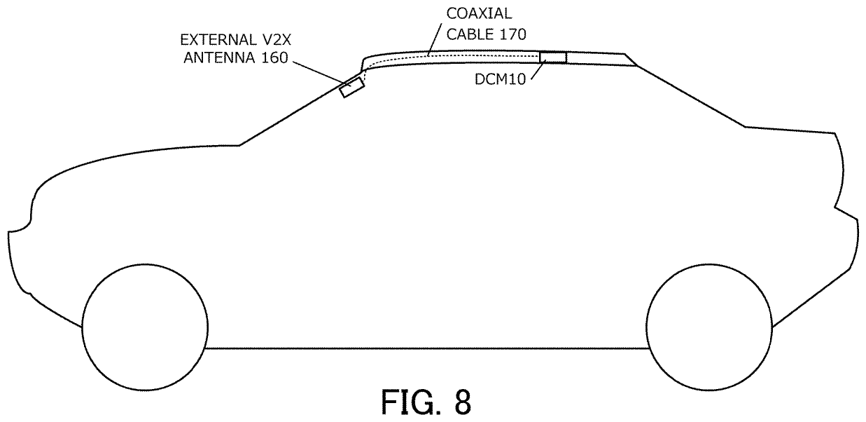

FIG. 8 is a diagram for describing an arrangement position of the external antenna. As illustrated in the drawing, in the second embodiment, a second V2X antenna (an external V2X antenna 160) is disposed at an upper part of the windshield. By disposing the external antenna toward front of the vehicle, a beam can be directed in a travel direction of the vehicle 1. The external V2X antenna 160 and the DCM 10 are connected by a coaxial cable 170.

In the present embodiment, the external V2X antenna 160 and the DCM 10 have to be connected by a coaxial cable. However, because the DCM 10 is disposed at a roof portion of the vehicle, a distance between the DCM 10 and the external V2X antenna 160 can be made as short as possible. That is, a wireless signal loss due to presence of a cable can be minimized while increasing sensitivity of V2X communication.

### MODIFICATIONS

The embodiments described above are merely examples, and the present disclosure may be changed as appropriate within the scope of the disclosure.

For example, in the description of the embodiments, the communication modules and the antennas that use V2X communication and cellular communication are cited as examples, but a plurality of sets of communication module and antenna compatible with other communication standards may be mounted on the DCM 10. As such communication methods, Wi-Fi (registered trademark), Bluetooth (registered trademark) and the like may be cited.

Furthermore, in the description of the embodiments, an example is cited where the wireless communication apparatus is disposed at a rear position of the roof panel of the vehicle, but the arrangement position is not limited as long as it is a position close to the roof panel of the vehicle. For example, the wireless communication apparatus may be disposed at a center or a front part of the roof panel of the vehicle.

What is claimed is:

1. A wireless communication apparatus comprising:
a communication module configured to perform wireless communication with an external network of a vehicle; and
a first antenna connected to the communication module, wherein
the wireless communication apparatus is mounted at a position close to a roof panel of the vehicle.

2. The wireless communication apparatus according to claim 1, wherein
the wireless communication apparatus is mounted between the roof panel and a roof lining of the vehicle.

3. The wireless communication apparatus according to claim 1, wherein
the communication module performs the wireless communication by V2X communication.

4. The wireless communication apparatus according to claim 3, further comprising
a port to which a second antenna is connected, the second antenna being an external antenna for the V2X communication.

5. The wireless communication apparatus according to claim 4, wherein
the second antenna is disposed at an upper part of a windshield of the vehicle.

6. The wireless communication apparatus according to claim 3, wherein
the wireless communication apparatus relays communication that is performed by an electronic control module that provides a vehicle function that uses the V2X communication, the electronic control module being mounted in the vehicle.

7. The wireless communication apparatus according to claim 3, wherein
the communication module further performs wireless communication with the external network of the vehicle by cellular communication.

8. The wireless communication apparatus according to claim 7, wherein
the wireless communication apparatus implements a function of transmitting position information of the wireless communication apparatus.

9. The wireless communication apparatus according to claim 8, further comprising
a third antenna configured to receive a signal transmitted from a positioning satellite.

10. The wireless communication apparatus according to claim 9, wherein
the third antenna is mounted at a position close to the roof panel of the vehicle.

11. A vehicle comprising a wireless communication apparatus that is mounted at a position close to a roof panel, the wireless communication apparatus including
a communication module configured to perform wireless communication with an external network of the vehicle, and
a first antenna connected to the communication module.

12. The vehicle according to claim 11, wherein
the wireless communication apparatus is mounted between the roof panel and a roof lining of the vehicle.

13. The vehicle according to claim 11, wherein
the communication module performs the wireless communication by V2X communication.

14. The vehicle according to claim 13, wherein
the wireless communication apparatus further includes a port to which a second antenna is connected, the second antenna being an external antenna for the V2X communication.

15. The vehicle according to claim 14, wherein
the second antenna is disposed at an upper part of a windshield of the vehicle.

16. The vehicle according to claim 13, further comprising
an electronic control module that provides a vehicle function that uses the V2X communication, wherein
the wireless communication apparatus relays communication that is performed by the electronic control module.

17. The vehicle according to claim 13, wherein
the communication module further performs wireless communication with the external network of the vehicle by cellular communication.

18. The vehicle according to claim 17, wherein
the wireless communication apparatus implements a function of transmitting position information of the wireless communication apparatus.

19. The vehicle according to claim 18, further comprising
a third antenna configured to receive a signal transmitted from a positioning satellite.

20. The vehicle according to claim 19, wherein
the third antenna is mounted at a position close to the roof panel of the vehicle.
